(19) United States
(12) Patent Application Publication
(10) Pub. No.: US 2003/0051645 A1
(43) Pub. Date: Mar. 20, 2003

(54) Apparatus for securing tobacco, alcohol, medications and method

(76) Inventor: Victor Dominic Rigatuso JR., Las Vegas, NV (US)

Correspondence Address: Mr. Victor D. Rigatuso Jr., 5855 Goodsprings Court, Las Vegas, NV, 89110, US

(21) Appl. No.: 09/953,843

(22) Filed: Sep. 17, 2001

(51) Int. Cl. E05G 1/00

(52) U.S. Cl. 109/23

(57) ABSTRACT

The Refrigerator Safe is a lockable container of any shape or size which can be locked by any means and is placed in a refrigerated unit. Said container can be made of high-impact, injection molded, corrosion resistant plastic or any material and can be built into new refrigerators, freezers, coolers, or installed into existing refrigerated appliances. Specially designed hinges on the door allow for easy removable which is preferable for cleaning and non-use. The Refrigerator Safe can prevent access to tobacco, alcohol, certain medications, foods or any other items stored in it without denying access to the rest of the refrigerator. The Refrigerator Safe can be used to dispense, by various methods, medicine, food or other items by manually pushing or pulling a lever or by any other releasing mechanism including but not limited to mechanically wound clock like timing devices, battery or electrically operated timed release methods. The safe can meet any present or future laws requiring devices to prevent access to the afore mentioned contents by juveniles or any other persons.

### CROSS-REFERENCE TO RELATED APPLICATIONS

Not Applicable

### STATEMENT REGARDING FEDERALLY SPONSORED RESEARCH OR DEVELOPMENT

Not applicable

### REFERENCE TO A MICROFICHE APPENDIX

Not applicable

### BACKGROUND OF INVENTION

Prior to contacting the PTO, I identified the many problems of accessibilty of tobacco, alcohol, medicine and food products by juveniles and others in the home and workplace which prompted the invention process; I then conceived the Refrigerator Safe. No attempts have been made to manufacture or market the Refrigerator Safe.

### BRIEF SUMMARY OF THE INVENTION

The Refrigerator Safe is a container that could be made in any size or shape and can be locked by any means that is placed or installed in a refrigerator or freezer to prevent access to any contents deposited within.

The Refrigerator Safe could be placed or installed in refrigerators or freezers to protect underage children and others by restricting accessibility of tobacco, alcohol, certain foods and medicines.

Most Refrigerator Safes could be manufactured in an off white color; however some safes could be made in different colors and styles to give the Refrigerator Safe a more designer look. The Refrigerator Safe can be made in a variety of sizes and can also be built permanently in new appliances simply by molding it into the interior of the appliance itself Specially designed hinges allow for the removal of the door when in the open position for cleaning and non-use.

The appealing features of the Refrigerator Safe would be its safety, practicality, convenience, durability, versatility, novelty, eye-catching design, reasonable price, cost-effectiveness, and ease of use.

### BRIEF DESCRIPTION OF SEVERAL VIEWS OF THE DRAWING

(Circled #s 1-7 are reference numerals in drawings)

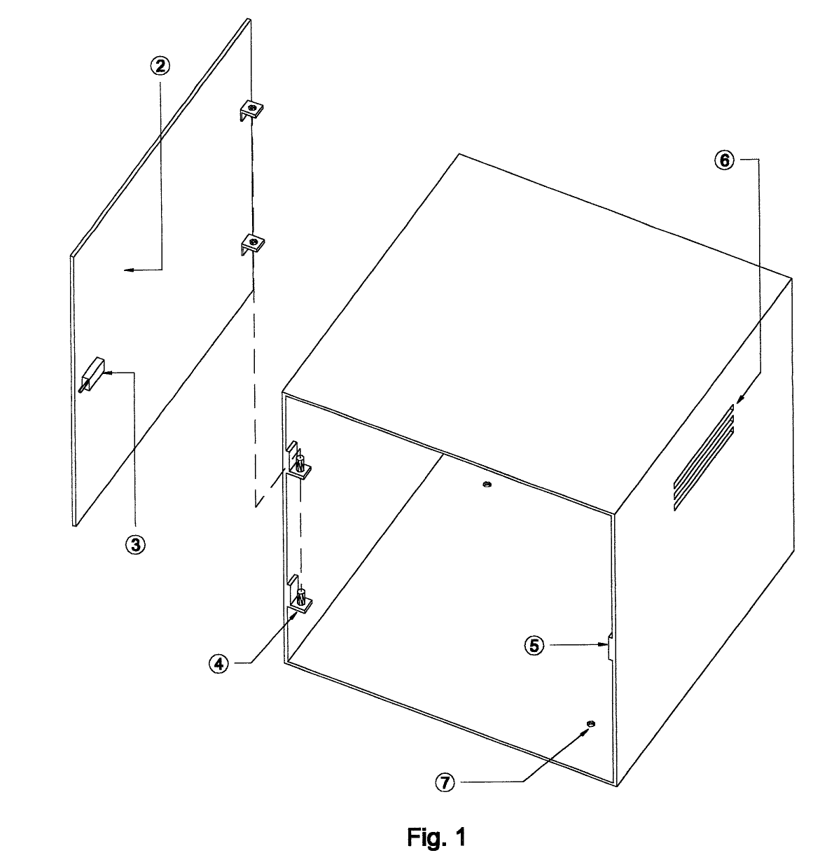

Main body (1) of Refrigerator Safe consisting of five sides (shown with front door unattached) could be made of any material although injection molding might be a standard approach to production. FIGS. 1,3,4

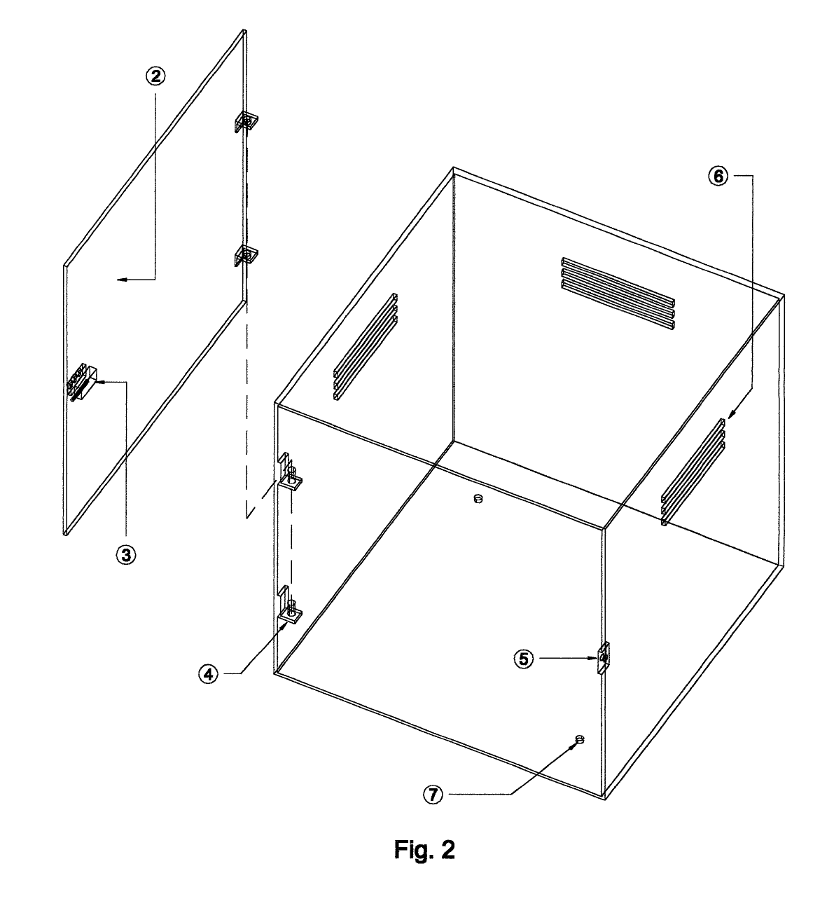

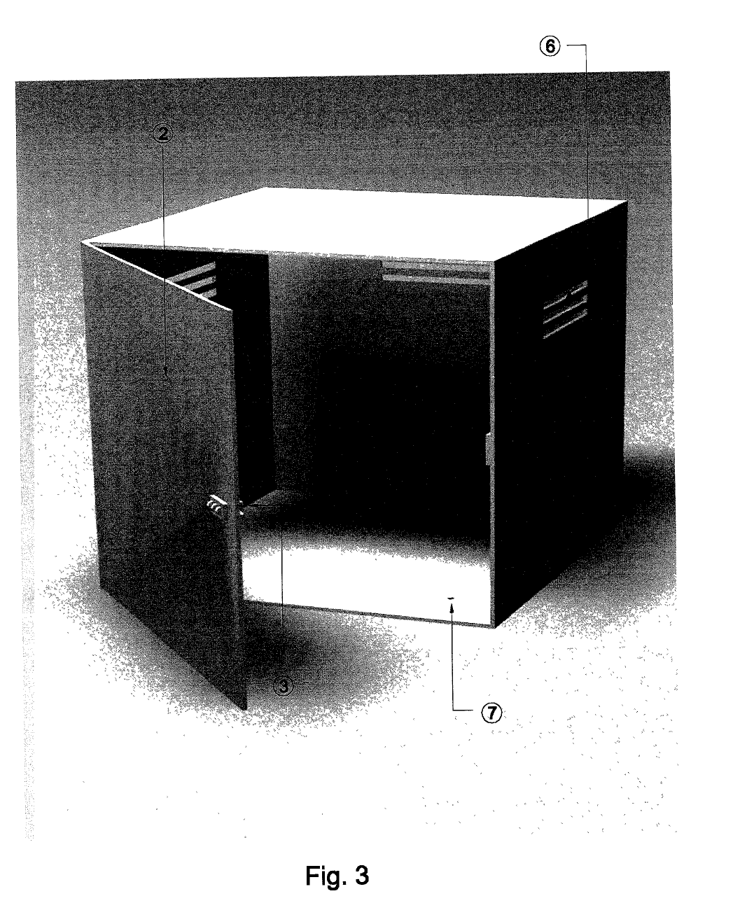

Front Door (2) contains means of locking or securing in any manner. (Shown unattached) FIGS. 2,3,5

Vents (3) located on sides or a side will allow ventilation (optional). No ventilation is required in many models. FIG. 1

Male studs or pins (4) expressly used for attaching female couplings of the front door may be molded into the main body. FIGS. 1,4

Female couplings (5) slide over male studs or pins to attach door. Allowing removal of the door if placed in any open position. The couplings may be molded into the door itself. FIGS. 2,5

Locking mechanism (6) this may encompass all locking devices known to lock or secure in any manner, although a combination lock may be preferred. FIGS. 2,3

Holes (7) located in main body can provide easy attachment to a refrigerator or freezer shelf (optional) FIG. 1

### DETAILED DESCRIPTION OF THE INVENTION

The Refrigerator Safe is a lockable container to be placed in a refrigerated appliance and is designed to restrict the access of tobacco, alcohol, medicine and food products to underage children and other household and workplace members. The safe could be made entirely from a high-impact, injection molded, corrosion resistant plastic which may be preferred; such as polycarbonate or polyvinylchloride. My invention can be built freestanding in any shape or configuration.

In designing the Refrigerator Safe, I took into account that a standard revolving locking mechanism could be made from the same corrosion resistant material. The user could select their personal combination and set it from inside the door. The combination lock is only suggested, a lock of any type may be used. This may encompass all locking devices known to lock or secure in any manner.

The Refrigerator Safe could be used to dispense, by various methods, medicine, food or other items by manually pushing or pulling a lever or by any other releasing mechanism. Including, but not limited to, mechanically wound clock like timing devices, battery, or other electrically operated timed release methods. Additional commercial applications, including but not limited to refrigerator manufacturers, can offer these devices as an additional cost item.

Specially designed hinges allow for the removal of the door when in the open position for cleaning and non-use. Vents (optional) located on all three sides of the safe can allow maximum air flow. The Refrigerator Safe does not require insulation or electricity, although the Refrigerator Safe could be insulated to keep its contents warm or cold for a predetermined period of time. Holes located in the bottom of the safe allow for easy attachment to the refrigerator shelf although any means of attachment can be used.

I claim my invention as:

1. A container made of any material in any size or shape or multiple containers within said container to be built into new refrigerated appliances or installed or placed in existing refrigerators, freezers or coolers which can be locked by any means therefore resrticting access to any contents such as medicine, food, tobacco or alcohol products placed therein by family, coworkers or roommates without denying access to the rest of the refrigerator.

2. I claim my inventon as:
A lockable container to be used inside refrigerated appliances which could meet any present or future laws requiring devices to prevent access to tobacco, alcohol, medicines or any other items by juveniles or any other persons.
